(19) United States
(12) Patent Application Publication
(10) Pub. No.: US 2007/0052878 A1
(43) Pub. Date: Mar. 8, 2007

(54) Thin film transistor arrray panel and a repairing method thereof

(75) Inventors: Keun-Kyu Song, Yongin-si (KR); Hyung-Il Jeon, Incheon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/518,560

(22) Filed: Sep. 7, 2006

(30) Foreign Application Priority Data
Sep. 7, 2005 (KR) 10-2005-0083037

(51) Int. Cl. G02F 1/1333

(52) U.S. Cl. 349/54

(57) ABSTRACT

According to an embodiment of the present invention, a thin film transistor array panel includes: an insulating substrate; a plurality of gate lines formed on the insulating substrate; a plurality of repairing lines formed on the same layer as the gate lines; a gate insulating layer formed on the gate lines and the repairing lines; a plurality of data lines formed on the gate insulating layer; a plurality of drain electrodes separated from the data lines and formed on the gate insulating layer; a passivation layer formed on the data lines and the drain electrodes; and a plurality of pixel electrodes formed on the passivation layer and connected to the drain electrodes, wherein the data lines include a first and a second data lines and a connecting bridge therebetween.

### CROSS-REFERENCE TO RELATED APPLICATION

This application claims priority to and the benefit of Patent Application No. 10-2005-0083037 filed on Sep. 7, 2005, in the Korean Intellectual Property Office, Republic of Korea, the entire content of which is incorporated by reference.

### BACKGROUND

(a) Field of the Invention

The present invention relates to a thin film transistor array panel and a display device including the same, and a repairing method of the display device.

(b) Description of Related Art

Recently, compact and lightweight flat panel displays such as an organic light emitting diode (OLED) display, plasma display panels (PDPs), and a liquid crystal displays (LCDs) have been actively developed as substitutes for the typically heavy and bulky cathode ray tubes (CRTs). The PDP, in particular, is a device that displays characters or images using plasma generated by a gas-discharge, and the organic electroluminescence display is a device that displays characters or images using electric field based light emitting properties of specific organic materials or polymers (high molecules). The LCD provides desired images by applying an electric field in a liquid crystal layer interposed between two panels where regulating the strength of the electric field is used to adjust the transmittance of light passing through the liquid crystal layer.

Among the flat panel displays, for example, the liquid crystal display and the organic electroluminescence display each include a display panel provided with pixels including switching elements and display signal lines, and a gate driver providing a gate signal for gate lines among the display signal lines to turn on/off the switching elements of the pixels. Although transparent glass is still generally used as substrates for these display panels, more recently plastic substrates are becoming prominent, especially for a small display. The plastic substrate has some advantageous properties including lower weight, greater flexibility, and durability. However, a plastic substrate is typically more susceptible to heat related problems than a glass substrate. Accordingly, the plastic substrate may expand due to a rise in temperature. This expansion may cause cracks on the plastic substrate that could induce a breaking or opening of signal lines or allow the entrance of impurities that could cause a shorting of signal lines.

The above background information is only intended to provide enhanced understanding of the various embodiments of the present invention and therefore the background information may contain information that is not considered to be prior art.

### SUMMARY

Progress in the development of at least one embodiment of the present invention has been made in an effort to provide a thin film transistor array panel that includes a means for repairing disconnected or shorted signal lines, a display device including the same, and a repairing method of the display device.

A thin film transistor array panel, according to an exemplary embodiment of the present invention, includes: an insulating substrate; a plurality of gate lines formed on the insulating substrate at a first layer; a plurality of repairing lines formed at the first layer; a gate insulating layer formed on the gate lines and the repairing lines; a plurality of data lines formed on the gate insulating layer; a plurality of drain electrodes separated from the data lines and formed on the gate insulating layer, each drain electrode forming a part of a thin film transistor; a passivation layer formed on the data lines and the drain electrodes; and a plurality of pixel electrodes formed on the passivation layer and connected to the drain electrodes, wherein each of the plurality of data lines includes a first and a second data line and a connecting bridge therebetween. The thin film transistor array panel may further comprise a plurality of branch lines configured to connect the repairing lines to the gate lines. Additionally, the insulating substrate may include plastic. Further, at least one connecting bridge may be used to fix a defect in at least one of a gate line, a data line, and a thin film transistor.

According to an exemplary embodiment of the present invention, a thin film transistor array panel comprises; an insulating substrate; a plurality of gate lines formed on the insulating substrate at a first layer; a plurality of repairing lines formed at the first layer; a plurality of branch lines connecting the repairing lines and the gate lines; a gate insulating layer formed on the gate lines, the repairing lines, and the branch lines; a plurality of first data lines formed on the gate insulating layer; a plurality of second data lines formed on the gate insulating layer; a plurality of drain electrodes separated from the first and second data lines and formed on the gate insulating layer; a passivation layer formed on the first and second data lines and the drain electrodes; and a plurality of pixel electrodes formed on the passivation layer and connected to the drain electrodes. The thin film transistor array panel may further comprise a plurality of connecting bridges configured to connect the first and the second data lines.

According to another exemplary embodiment of the present invention, a method of repairing a thin transistor array panel that comprises an insulating substrate, a plurality of gate lines formed on the insulating substrate, a plurality of repairing lines formed on the insulating substrate, a plurality of branch lines connecting the gate lines and the repairing lines, a plurality of first data lines and a plurality of second data lines intersecting the gate lines and the repairing lines, a plurality of bridges connecting the first data lines and the second data lines, a plurality of thin film transistors connected to the gate line and the first data lines, and a plurality of pixel electrodes connected to the thin film transistors, the method comprising: shorting two adjacent second data lines with two adjacent repairing lines; disconnecting portions of the second data lines connecting the two adjacent repairing lines from the other portions of the second data lines and the first data lines; and disconnecting a portion of one of the repairing line connecting the two adjacent second data lines from the other portions of the repairing line and the gate lines.

According to yet another exemplary embodiment of the present invention, a method of repairing a thin film transistor array panel that comprises an insulating substrate, a plurality of gate lines formed on the insulating substrate, a plurality of repairing lines formed on the insulating substrate, a plurality of branch lines connecting the gate lines and the repairing lines, a plurality of first data lines and a plurality of second data lines intersecting the gate lines and the repairing lines, a plurality of bridges connecting the first data lines and the second data lines, a plurality of thin film transistors connected to the gate line and the first data lines, and a plurality of pixel electrodes connected to the thin film transistors, the method comprising: shorting a first data line and a second data line adjacent to each other with two adjacent repairing lines; disconnecting portions of the second data lines connecting the two adjacent repairing lines from the other portions of the second data lines and the first data lines; and disconnecting portions of the repairing lines connecting the first data line and the second data line from the other portions of the repairing lines and the gate lines.

### BRIEF DESCRIPTION OF THE DRAWINGS

The accompanying drawings briefly described below illustrate exemplary embodiments of the present invention and, together with the description, serve to explain the principles of the present invention.

FIG. 1 shows a block diagram of a liquid crystal display according to an exemplary embodiment of the present invention.

FIG. 2 shows an equivalent circuit for a pixel of a liquid crystal display according to an exemplary embodiment of the present invention.

FIG. 3 shows a layout view for a structure of a thin film transistor array panel according to an exemplary embodiment of the present invention.

FIG. 4A and FIG. 4B show cross-sectional views of the thin film transistor array panel shown in FIG. 3 taken along line IVA-IVA and IVB-IVB.

FIG. 5 to FIG. 7 show illustrations of various repairing examples of the thin film transistor array panel shown in FIG. 3.

### DETAILED DESCRIPTION

The present invention will now be described more fully hereinafter with reference to the accompanying drawings, in which preferred embodiments of the invention are shown. In the drawings, the thickness of layers, films, panels, regions, etc. may be exaggerated for clarity. Like reference numerals designate like elements throughout the specification. It will be understood that when an element such as a layer, film, region or substrate is referred to as being “on” another element, it may be directly on the other element or one or more intervening elements may also be present. In contrast, when an element is referred to as being “directly on” another element, there are no intervening elements present.

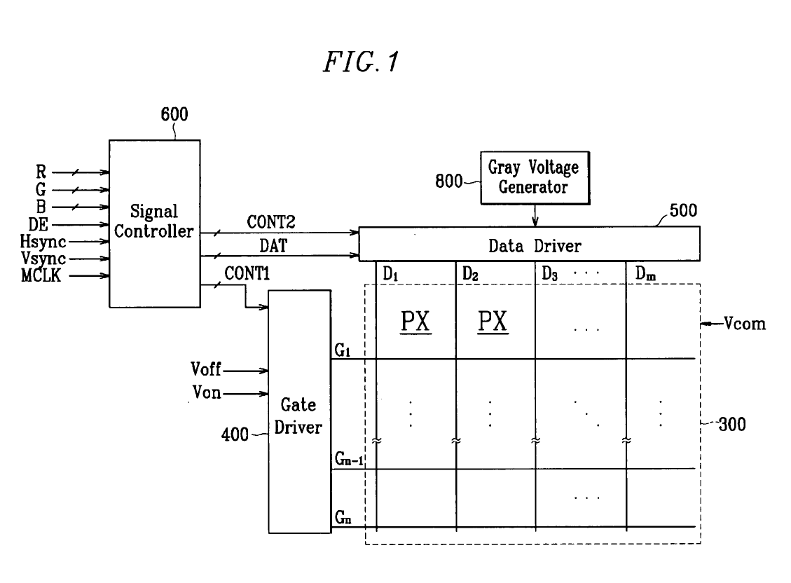

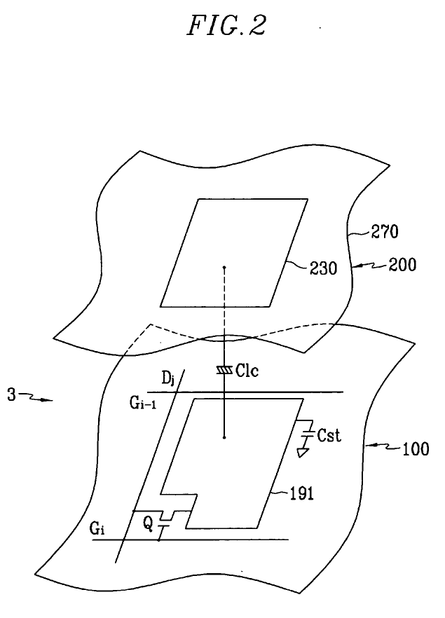

First, a liquid crystal display, as an example of a display device according to an embodiment of the present invention, will be described in detail with reference to FIG. 1 and FIG. 2. FIG. 1 shows a block diagram of a liquid crystal display according to an exemplary embodiment of the present invention, while FIG. 2 shows an equivalent circuit for a pixel of a liquid crystal display according to exemplary embodiment of the present invention. In this disclosure, terms like above, below, horizontal, vertical, left, right, upper, and lower, are relative position terms and describe the position of one element in reference to another element based on a particular orientation or frame of reference that may or may not be shown in the drawings. Hence, when the described element, combination, apparatus, or a portion thereof is turned over, a first element that was above a second element prior to the turning may now be oriented below that second element after the turning. Hence, these terms are not considered limiting.

As shown in FIG. 1, the liquid crystal display according to an exemplary embodiment of the present invention includes the liquid crystal panel assembly 300, the gate driver 400 and the data driver 500 connected to the liquid crystal panel assembly 300, the gray voltage generator 800 connected to the data drive 500, and the signal controller 600 that controls the above-described elements. As can be seen from an equivalent circuit, the liquid crystal panel assembly 300 includes a plurality of signal lines G1 to Gn and D1 to Dm and a plurality of pixels PX connected to the plurality of signal lines G1 to Gn and D1 to Dm and arranged substantially in a matrix or array-like manner.

Meanwhile, as shown in FIG. 2, the liquid crystal panel assembly 300 includes a lower panel 100 and an upper panel 200 facing each other, and a liquid crystal layer 3 filled between the lower panel 100 and the upper panel 200. The signal lines G₁ to Gₙ and D₁ to Dₘ include a plurality of the gate lines G₁ to Gₙ that transmit gate signals (hereinafter, also referred to as “scanning signal”) and a plurality of the data lines D₁ to Dₘ that transmit data signals. The gate lines G1 to Gn extend substantially in a row direction and are substantially parallel to each other. The data lines D1 to Dm extend substantially in a column direction and are substantially parallel to each other. Each pixel PX, for example, a pixel PX connected to the i-th gate line Gi (where i=1, 2, . . . , and n) and the j-th data line Dj (where j=1, 2, . . . , and m) includes a switching element Q that is connected to the signal lines Gi and Dj, a liquid crystal capacitor Clc, and a storage capacitor Cst that are connected to the switching element Q. Storage capacitor Cst may be omitted if necessary.

The switching element Q is a three-terminal element, such as a thin film transistor that is provided on the lower panel 100, and it includes a control terminal connected to the gate line Gᵢ, an input terminal connected to the data line Dⱼ, and an output terminal connected to the liquid crystal capacitor Clc and the storage capacitor Cst. The liquid crystal capacitor Clc includes a pixel electrode 191 formed on the lower panel 100 and a common electrode 270 formed on the upper panel 200 as two terminals, and the liquid crystal layer 3 interposed between the two electrodes 191 and 270 serves as a dielectric material.

The pixel electrode 191 is connected to the switching element Q, and the common electrode 270 is formed on an entire surface of the upper panel 200 and a common voltage Vcom is applied to the common electrode. Unlike the pixel shown in FIG. 2, the common electrode 270 may be provided on the lower panel 100. In this case, at least one of the pixel electrode 191 and the common electrode 270 may be formed in a linear or bar shape. The storage capacitor Cst is an auxiliary capacitor for the liquid crystal capacitor Clc. The storage capacitor Cst has a structure in which an additional signal line (not shown) and the pixel electrode 191 provided on the lower panel 100 overlap each other with an insulator therebetween, and a predetermined voltage, such as the common voltage Vcom, is applied to the additional signal line. However, the storage capacitor Cst may be configured such that the pixel electrode 191 overlaps a previous gate line with an insulator therebetween. Meanwhile, in order to implement a color display, the individual pixels may uniquely display one color of the primary colors (spatial division) or the individual pixels alternately display the primary colors (temporal division), such that a spatial or temporal sum of the primary colors is recognized as a desired color. Examples of primary colors may be red, green and blue.

FIG. 2 shows an example of the spatial division. In FIG. 2, each pixel PX includes a color filter 230 representing one color of the primary colors in a region of the upper panel 200 corresponding to the pixel electrode 191. Unlike the structure shown in FIG. 2, the color filter 230 may be provided above or below the pixel electrode 191 of the lower panel 100. At least one polarizer (not shown) for polarizing light is attached to an outer surface of the liquid crystal panel assembly 300. Referring again briefly to FIG. 1, the gray voltage generator 800 generates two sets of gray voltages (or two sets of reference gray voltages) related to the transmittance of the pixel PX. One set of the two sets of gray voltages has a positive value with respect to the common voltage Vcom, and the other set has a negative value with respect to the common voltage Vcom.

The gate driver 400 is connected to the gate lines G₁ to Gₙ of the liquid crystal panel assembly 300 and applies the gate signal of the gate-on voltage Von and gate-off voltage Voff to the gate lines G₁ to Gₙ. The data driver 500 is connected to the data lines D₁ to Dₘ of the liquid crystal panel assembly 300, selects the gray voltages generated by the gray voltage generator 800, and applies the selected gray voltages to the data lines D₁ to Dₘ as the data signals. However, when the gray voltage generator 800 generates only a predetermined number of the reference gray voltages, not voltages for all gray levels, the data driver 500 divides the reference gray voltages to generate the gray voltages for all the gray levels and selects the data signals from the gray voltages. A signal controller 600 controls the operation of the gate driver 400 and the data driver 500.

Each of the driving devices 400, 500, 600, and 800 may be directly mounted on the liquid crystal panel assembly 300 in the form of at least one IC chip or maybe mounted on a flexible printed circuit film (not shown) and attached to the liquid crystal panel assembly 300 as a TCP (tape carrier package). Further, each driving device may be mounted on a separate printed circuit board (PCB) (not shown). Alternately, these driving devices 400, 500, 600, and 800 may be integrated into the liquid display panel assembly 300 together with the signal lines G1 to Gn and D1 to Dm and the thin film transistor switching elements Q, and so on. In addition, the driving devices 400, 500, 600, and 800 may be integrated into a single chip. In this case, at least one of the driving devices 400, 500, 600 and 800 or at least one circuit element in the driving devices 400, 500, 600, and 800 may be provided outside the single chip.

The operation of the above-described liquid crystal display will be described in detail below. The signal controller 600 receives input image signals R, G, and B and input control signals for controlling the display thereof from an external graphics controller (not shown). The input control signals include, for example, a vertical synchronization signal Vsync, a horizontal synchronizing signal Hsync, a main clock signal MCLK, and a data enable signal DE. On the basis of the input image signals R, G, and B and the input control signals, the signal controller 600 appropriately processes the input image signals R, G, and B in accordance with the operating conditions of the liquid crystal panel assembly 300 to generate a gate control signal CONT1, a data control signal CONT2. Then, the signal controller 600 outputs the gate control signal CONT1 to the gate driver 400, outputs the data control signal CONT2 and the processed image signal DAT to the data driver.

The gate control signal CONT1 includes a scanning start signal STV for commanding the start of scanning and at least one clock signal for controlling the output period of the gate-on voltage Von. The gate control signal CONT1 may further include an output enable signal OE for defining the duration time of the gate-on voltage Von. The data control signal CONT2 includes a horizontal synchronization start signal STH for identifying the start of data transmission for a row (group) of pixels PX, a load signal LOAD for commanding the application of the data signals to the data lines D₁ to Dₘ, and a data clock signal HCLK. The data control signal CONT2 may further include an inversion signal RVS for reversing the polarity of the voltage of the data signals with respect to the common voltage Vcom (hereinafter, “the polarity of the voltage of the data signals with respect to the common voltage” is simply referred as “the polarity of the data signals”).

In accordance with the data control signal CONT2 from the signal controller 600, the data driver 500 receives digital image signals DAT for a row of pixels PX, converts the digital image signals DAT into analog data signals by selecting the gray voltages corresponding to the respective digital image signals DAT, and applies the converted analog data signals to the data lines D1 to Dm. The gate driver 400 applies the gate-on voltage Von to the gate lines G1 to Gn in accordance with the gate control signal CONT1 from the signal controller 600, thereby turning on the switching elements Q connected to the gate lines G1 to Gn. Then, the data signals applied to the data lines D1 to Dm are supplied to the corresponding pixels PX through the switching elements Q having been turned on. The difference between the voltage of the data signal and the common voltage Vcom applied to the pixel PX is represented as a charging voltage of the liquid crystal capacitor Clc, which is referred to as a pixel voltage.

Liquid crystal molecules have different arrangements in accordance with the magnitude of the pixel voltage, so that the polarization of light passing through the liquid crystal layer 3 is changed. The change of the polarization becomes a change in transmittance of light by a polarizer that is attached to the liquid crystal display panel assembly 300. By repeating the above-mentioned processes while using one horizontal period (referred as “1H” and equal to one period of the horizontal synchronizing signal Hsync and the data enable signal DE) as a unit, the gate-on voltage Von is sequentially applied to all the gate lines G₁ to Gₙ, thereby the data signals are applied to all the pixels PX; as a result, an image of a frame is displayed.

When the next frame starts after one frame is completed, the state of the inversion signal RVS that is applied to the data driver 500 is controlled such that the polarity of the data signal applied to each of the pixels PX is inverted (“frame inversion”) with respect to the polarity of the previous frame. At this time, the polarity of the data signal that flows in one data line is inverted (for example, row inversion and dot inversion) or the polarities of the data signals that are applied to a row of pixels are inverted (for example, column inversion and dot inversion), according to the characteristics of the inversion signal RVS during one frame.

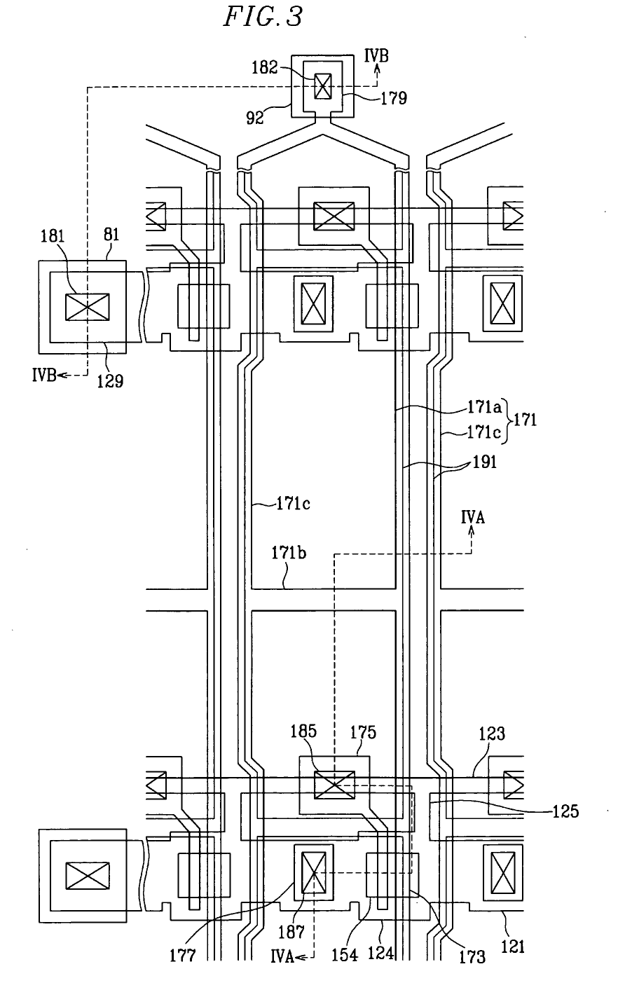

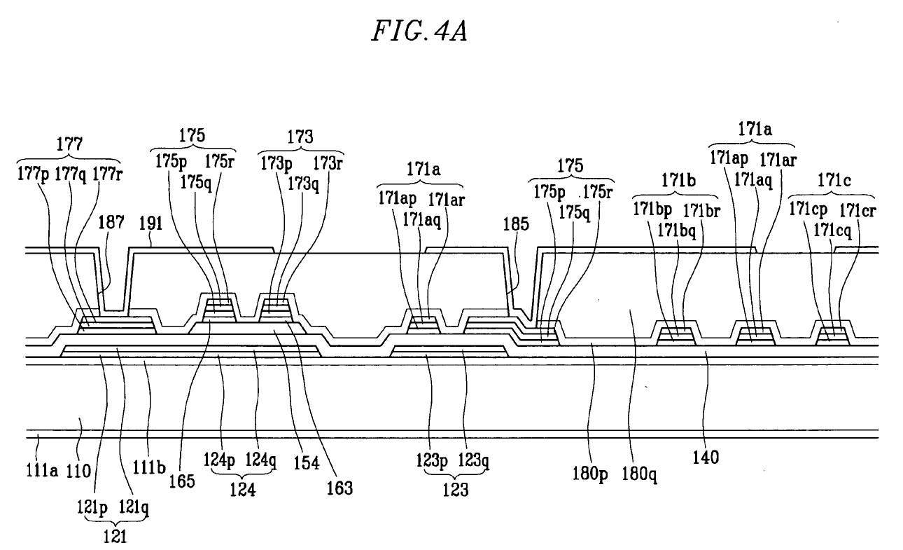

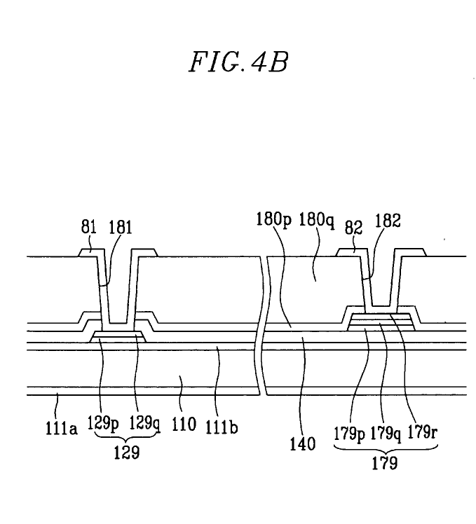

Now, the structure of a thin film transistor array panel according to an exemplary embodiment of the present invention will be described in detail with reference to FIG. 3 to FIG. 4B. FIG. 3 shows a layout view of a thin film transistor array panel for a liquid crystal display according to an exemplary embodiment of the present invention. FIG. 4A and FIG. 4B show cross-sectional views of a thin film transistor array panel taken along the line IVA-IVA and IVB-IVB of FIG. 3. A thin film transistor array panel according to the present exemplary embodiment includes a plastic insulating substrate 110 and a lower protecting layer 111a and an upper protecting layer 111b respectively formed on the top and bottom surfaces of the substrate 110. The lower protecting layer 111a and the upper protecting layer 111b are made of non-organic material such as oxide(SiO₂) or silicon nitride(SiNₓ) or organic materials.

The substrate 110 may be made of one or more materials chosen among polyacrylate, polyethyleneether phtalate, polyethylene naphthalate, polycarbonate, polyarylate, polyetherimide, polyethersulfon or polyimide etcetera, and may have multiple layers. Although it is preferable that the protection layers 111a and 111b, preventing oxygen or moisture from permeating into the substrate 110, are formed on both of the top and bottom surface of the plastic substrate 110, one of the protection layers 111a and 111b or both of them may be omitted. A plurality of gate lines 121 transmitting gate signals and repairing lines 123 are formed on the substrate passivation layer 111b. In this manner, the plurality of gate lines 121 and the plurality of repairing lines 123 are formed at the same layer. The gate lines 121 mainly extend in the horizontal direction. Each gate line 121 includes a plurality of gate electrodes 124 and a wide end portion 129 for the connection with other layer or an external driving circuit. Each repairing line 123 includes a stem line that is substantially parallel to the gate lines 121 and a plurality of branch lines 125 that are connected to an adjacent gate line 121. Agate driving circuit (not shown) generating gate signals may be mounted on a flexible printed circuit film (not shown) disposed on the substrate 110 or directly mounted on the substrate 110 or integrated on the substrate 110.

When the gate driving circuit is directly integrated on the substrate 110, the gate lines 121 may be extended and directly connected to the gate driving circuit. The gate lines 121 and the repairing lines 123 include two conductive layers which have different physical properties, and are lower layers 121p and 123p and upper layers 121q and 123q, respectively. The lower layers 121p and 123p are made of a metal having low resistivity, for example, an Al containing metal such as Al or an Al alloy, an Ag containing metal such as Ag or an Ag alloy, and a Cu containing metal such as Cu or a Cu alloy etc., to reduce signal delay and voltage drop. On the other hand, the upper layers 121q and 123q are made of a material such as Mo containing metal including Mo, Mo alloy, and Mo nitride, Cr, Ta, or Ti, which has good physical, chemical, and electrical contact characteristics with other materials especially indium tin oxide (ITO) or indium zinc oxide (IZO). An exemplary construction includes lower layers 121p and 123p composed of Al or Al alloy and the upper layers 121q and 123q composed of Mo or Mo alloy. Lower layer 121p is electrically connected to lower layer 124p, and upper layer 121q is electrically connected to upper layer 124q.

The lower layers 121p and 123p may be made of a material having good contact characteristic; upper layers 121q and 123q may be made of a material having low resistance. In this case, a lower layer 129p of the end portion 129 may be exposed by removing a portion of an upper layer 129q of the end portion 129. Additionally, the gate lines 121 may have single layered structure including various materials described above and may also be composed of other metals or conductors.

In FIG. 4A and FIG. 4B, ‘p’ representing the lower layer and ‘q’ representing the upper layer are used for the gate electrode 124, the repairing line 123, and the branch line 125 as reference numerals. The lateral surfaces of the gate lines 121 and the repairing lines 123 are inclined relative to a surface of the substrate 110, and the inclination angle thereof ranges about 30-80 degrees. A gate insulating layer 140 preferably made of silicon nitride (SiNx) or silicon oxide (SiOx) is formed on the gate lines 121 and the repairing lines 123.

A plurality of island shaped semiconductors 154 preferably made of hydrogenated amorphous silicon (abbreviated to “a-Si”) or polysilicon are formed on the gate insulating layer 140. The semiconductors 154 are located on the gate electrodes 124. A plurality of island shaped ohmic contacts 163 and 165 are formed on the semiconductors 154. The ohmic contacts 163 and 165 may be made of n+ hydrogenated a-Si which is a-Si heavily doped with n type impurity such as phosphorous or may be made of a silicide. The ohmic contacts 163 and 165 are disposed in pairs on the semiconductors 154. The lateral surfaces of the semiconductors 154 and the ohmic contacts 163 and 165 are inclined relative to the surface of the substrate 110, and the inclination angles thereof are preferably in a range of about 30-80 degrees.

A plurality of data lines 171, a plurality of drain electrodes 175, and a plurality of storage conductors 177 are formed on the ohmic contacts 163 and 165 and the gate insulating layer 140. Each data line 171 transmits data signals and includes a main data line 171a and a sub data line 171c which are respectively disposed on the right side and the left side of a pixel. The main data line 171a and 171c extend in a vertical direction so as to intersect the gate lines 121 and the repairing lines 123. The main data line 171a and the sub data line 171c are connected to each other through a plurality of connecting bridges 171b. The main data lines 171a include a plurality of source electrodes 173 overlapping the gate electrodes 124. The sub data line 171c become further from an adjacent data line 171a around the gate lines 121 and get closer to the adjacent data line 171a again out of the gate lines 121. The sub data lines 171c and the connecting bridges 171b may be used to fix defects of the gate lines 121, the data lines 171a or the thin film transistors.

A data driving circuit (not shown) generating data signals may be mounted on a flexible printed circuit film (not shown) attached on the substrate 110 or directly mounted on the substrate 110. The data driving circuit may be integrated on the substrate 110. When the data driving circuit is integrated on the substrate 110, the data lines 171 may extend to be directly connected to the data driving circuit. The drain electrodes 175 are separated from the data lines 171 and face the source electrodes 173 with the gate electrodes 124 interposed therebetween. Each of the drain electrodes 175 has a wide end and a rod-shaped end. The wide end overlaps the repairing lines 123 and the rod-shaped end extends to be parallel to the source electrodes 173.

A thin film transistor is formed of each one of the gate electrodes 124, the source electrodes 173, the drain electrodes 175, and the semiconductors 154. A channel of the thin film transistor is formed on the semiconductor 154 located between the source electrode 173 and the drain electrode 175. The storage conductors 177 overlap the gate lines 121. An end portion 179 of the data line 171 has wider width than other portions of the data line 171 to be connected with other layers or an outside device. The main data line 171a and the sub data line 171c gather at near the end portion 179. However, the main data line 171a and the sub data line 171c may respectively have a wide end portion or only one of the main data line 171a and the sub data line 171c may have a wide end portion. The data lines 171 and the drain electrodes 175 have three layers comprising lower layers 171p and 175p, middle layers 171q and 175q, and upper layers 171r and 175r. The lower layers 171p and 175p are made of a refractory metal or its alloy such as molybdenum, chromium, tantalum and titanium, etc. The middle layers 171q and 175q are made of a low resistance metal such as the aluminum series, silver series, and copper series metals, etc. The upper layers 171r and 175r are made of a refractory metal having good contact characteristics with ITO or IZO, and their alloys. An exemplary construction of this triple layered structure is the lower layer of molybdenum (alloy), the middle layer of aluminum (alloy), and the upper layer of molybdenum (alloy).

The data lines 171 and the drain electrodes 175 may have a dual-layered structure including a lower layer (not shown) of a refractory metal and an upper layer (not shown) of a low resistant metal or a single layered structure made of the materials as described above. An exemplary construction of the dual-layered structure includes chromium or molybdenum (alloy) for the lower layer and aluminum (alloy) for the upper layer. The data lines 171 and the drain electrodes 175, however, may be made of various other metals or conductors.

In FIG. 4A and FIG. 4B, the letters, ‘p’, ‘q’, and ‘r’ respectively standing for the lower layer, the middle layer, and the upper layer are used for the connecting bridges 171b, the source electrodes 173, and the storage conductors 177. The lateral surfaces of the data lines 171, the drain electrodes 175, and the storage conductors 177 are inclined relative to a surface of the substrate 110 and the inclination angle thereof ranges about 30-80 degrees. The ohmic contact members 163 and 165 are interposed only between the underlying semiconductors 154 and the overlying data lines 171 and drain electrodes 175, thereby reducing contact resistance. The semiconductors 154 have exposed portions that are located between the source electrodes 173 and the drain electrodes 175 and are not covered with the data lines 171 and the drain electrodes 175.

A passivation layer 180 is formed on the data lines 171, the drain electrodes, 175 and the exposed portions of the semiconductors 154. The passivation layer 180 includes a lower layer 180p made of an inorganic insulator such as silicon nitride or silicon oxide etcetera, and an upper layer 180q made of an organic insulator. The organic insulator preferably has a dielectric constant less than 4.0 and it may have photosensitivity and a flat surface. The passivation layer 180 may have a single layered structure made of an inorganic insulator or an organic insulator.

A plurality of contact holes 182, 185, and 187 that expose the end portions 179 of the data lines 171, the drain electrodes 175, and the storage conductors 177 and are formed in the passivation layer 180. A plurality of contact holes 181 exposing the end portions 129 of the gate lines 121 are also formed in the passivation layer 180 and in the gate insulating layer 140. A plurality of pixel electrodes 191 and a plurality of contact assistants 81 and 82 are formed on the passivation layer 180. These may be made of transparent conductive materials such as ITO or IZO, or reflective materials such as aluminum or silver or chromium and/or their alloys.

The pixel electrodes 191 are physically and electrically connected to the drain electrodes 175 through the contact holes 185 and supplied data voltages from the drain electrodes 175. The pixel electrodes 191 that are applied with the data voltage forms an electric field along with the common electrode 270 of the upper panel 200, which is applied with the common voltage to determine the direction of liquid crystal molecules of the liquid crystal layer 3 interposed between the electrodes 191 and 270. The polarization of the light passing through the liquid crystal layer 3 may be changed by the determined direction of the liquid crystal molecules. The pixel electrodes 191 and the common electrodes constitutes a storage capacitor Cst, thereby maintaining the applied voltage even after the thin film transistor is turned off.

The contact assistants 81 and 82 are respectively connected to the end portions 129 and 179 of the gate lines 121 and the data lines 171 through the contact holes 181 and 182. The contact assistants 81 and 82 improve the adhesion of the end portions 129 and 179 of the gate lines 121 and the data lines 171 with the external circuit and protect the end portions 129 and 179 of the gate lines 121 and the data lines 171.

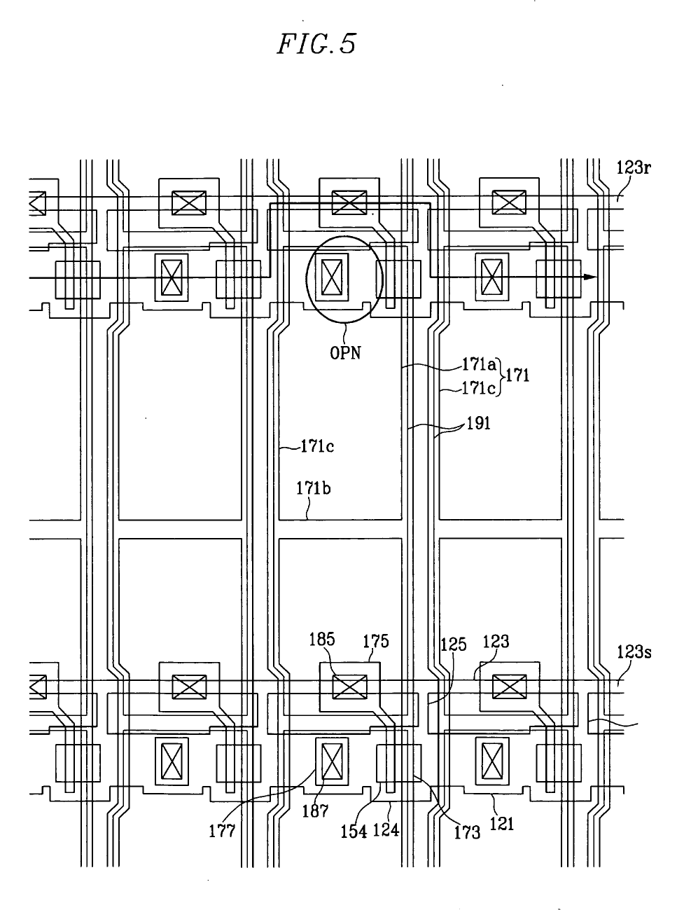

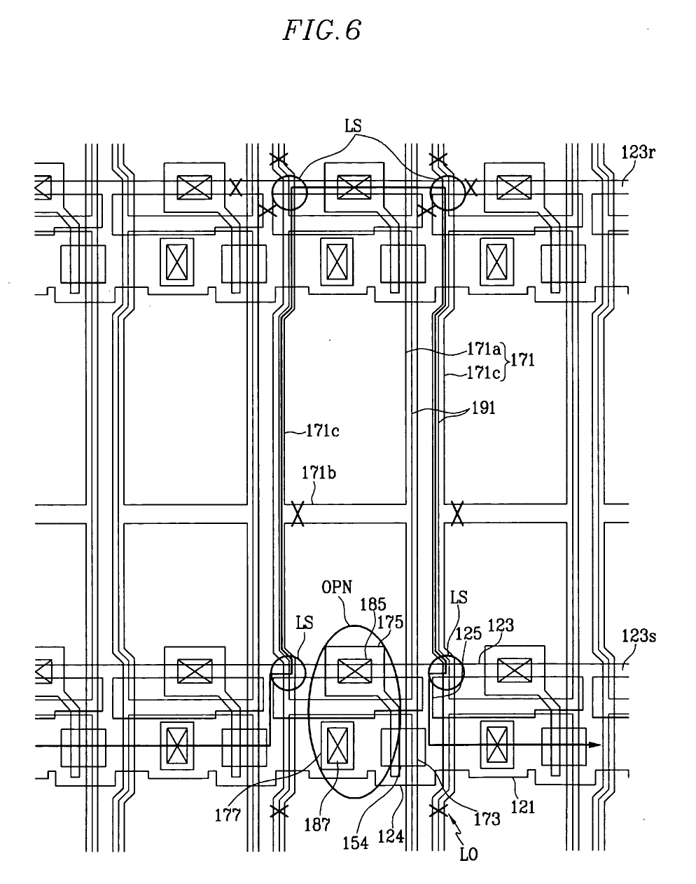

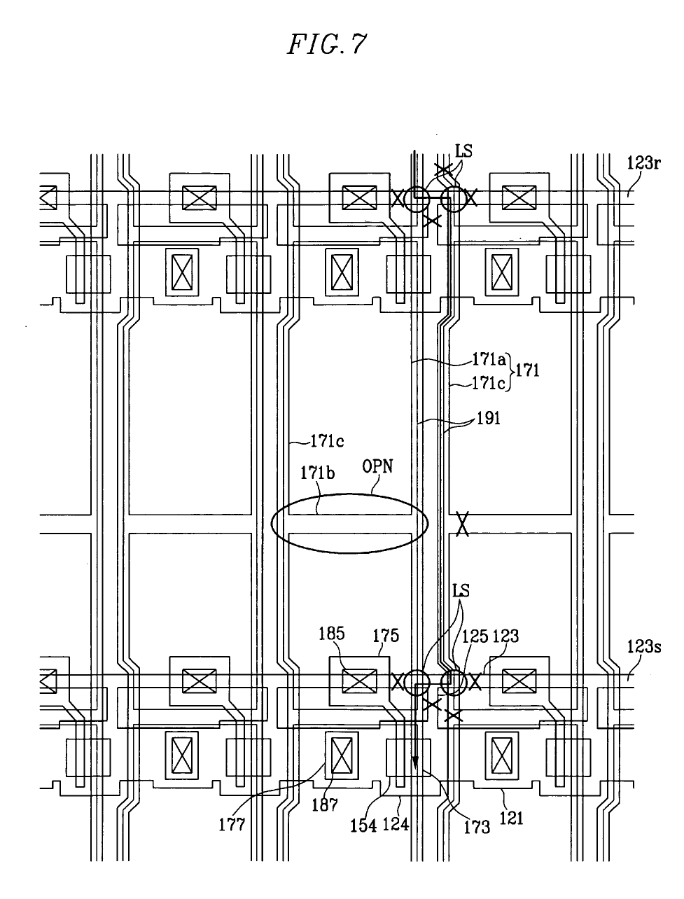

Now, a method of repairing according to the exemplary embodiment of the present invention will be described in detail referring to FIG. 5 to FIG. 7 that show illustrations of various repairing examples of the thin film transistor array panel shown in FIG. 3. FIG. 5 illustrates a repairing example when one of the gate lines 121 is disconnected (open/broken), FIG. 6 shows an illustration of a repairing example when both the gate line 121 and the repairing line 123 are disconnected, and FIG. 7 shows an illustration of a repairing example when the data lines 171a and 171c and the connecting bridge 171b are disconnected.

In the following description, the reference character ‘OPN’ stands for a disconnected or open portion, ‘LS’ represents a portion shorted by a laser illumination (e.g. the application of laser energy), and ‘LO’ stands for a portion disconnected by a laser illumination. In FIG. 5, the gate line 121 is broken at a mid portion between the main data line 171a and the sub data line 171c. The gate signal illustrated as an arrow is transmitted through a route detouring around the disconnected portion OPN, which follows the branch line 125, the repairing line 123r, and the other branch line 125. Accordingly, and as shown in FIG. 5, when only one of the gate lines 121 is broken, the thin film transistor array panel 100 still works without requiring any repair operation.

In FIG. 6, both the gate line 121 and the repairing line 123s are broken. To repair this defect, the repairing line 123s of the present pixel row, where the broken portion OPN is located, is shorted to the sub data lines 171c which are disposed at left side and right side of the broken portion OPN through laser illuminations (indicated by a circle). The repairing line 123r of the previous pixel row is shorted to the sub data lines 171c which are disposed at left side and right side of the broken portion OPN through laser illuminations (indicated by a circle). The portions of the sub data lines 171c, which connect the present repairing line 123s and the previous repairing line 123r, are disconnected from the other portions of the sub data lines 171c and the main data line 171a by cutting the upper and lower points of the shorted points and cutting the connecting bridge 171b through laser illumination (e.g. the application of laser energy). The portion of the previous repairing line 123r, which connects the sub data lines 171c, is disconnected from the other portions of the previous repairing line 123r and the previous gate line 121 by cutting the left and right points of the shorted points and cutting the branch lines 125 through laser illuminations. When the repair is completed, the gate signal is then transmitted along the conductor in the direction shown by the arrow.

According to FIG. 7, the main and the sub data lines (171a, 171c) and the connecting bridge 171b of one pixel are broken. Therefore, the data voltages are not transmitted or conducted. To repair, the repairing line 123s of the present pixel row, where the broken portion OPN is located, is shorted to the main data line 171a which is broken and to the sub data line 171c which are disposed at right side of the broken portion OPN through laser illuminations (indicated by a circle: LS). The repairing line 123r of the previous pixel row, is shorted to the main data line 171a which is broken and to the sub data line 171c which are disposed at right side of the broken portion OPN through laser illuminations (indicated by a circle: LS).

The portions of the sub data line 171c, which connects the present repairing line 123s and the previous repairing line 123r, is disconnected from the other portions of the sub data line 171c and the main data line 171a by cutting the upper and lower points of the shorted points (LS) and cutting the connecting bridge 171b through laser illuminations. The portions of the previous repairing lines 123r and 123s, which connect the sub data line 171c and the main data line 171a, are disconnected from the other portions of the repairing lines 123r and 123s and the gate lines 121 by cutting the left and right points of the shorted points and cutting the branch lines 125 through laser illuminations. When the repair operation is completed, the gate signal is transmitted along the conductor in the direction of the arrow.

The plastic substrate 110 may be affected by the laser illumination when shorting and cutting. However, the lower plastic substrate 110 is not damaged when a NdYAG laser is used as a laser light/illumination source. As described above, when the repairing lines are formed in parallel to the gate lines 121, defects may be repaired no matter how many defects have occurred. Additionally, the repairing lines 123 form a redundancy for the gate lines 121. Accordingly, and as shown in FIG. 5, when only the gate lines 121 are broken, the thin film transistor array panel 100 still works without requiring any repair operation.

Although preferred embodiments of the present invention have been described in detail hereinabove, it should be clearly understood that many variations and/or modifications of the basic inventive concepts herein taught which may appear to those skilled in the present art will still fall within the spirit and the scope of the present invention, as defined in the appended claims.

What is claimed is:

1. A thin film transistor array panel, comprising:
an insulating substrate;
a plurality of gate lines formed on the insulating substrate at a first layer;
a plurality of repairing lines formed at the first layer;
a gate insulating layer formed on the gate lines and the repairing lines;
a plurality of data lines formed on the gate insulating layer;
a plurality of drain electrodes separated from the data lines and formed on the gate insulating layer, each drain electrode forming a part of a thin film transistor;
a passivation layer formed on the data lines and the drain electrodes; and
a plurality of pixel electrodes formed on the passivation layer and connected to the drain electrodes,
wherein each of the plurality of data lines includes a first and a second data line and a connecting bridge therebetween.

2. The thin film transistor array panel of claim 1, further comprising a plurality of branch lines configured to connect the repairing lines to the gate lines.

3. The thin film transistor array panel of claim 1, wherein the insulating substrate includes plastic.

4. The thin film transistor array panel of claim 1, wherein at least one connecting bridge may be used to fix a defect in at least one of a gate line, a data line, and a thin film transistor.

5. A thin film transistor array panel, comprising:
an insulating substrate;
a plurality of gate lines formed on the insulating substrate at a first layer;
a plurality of repairing lines formed at the first layer;
a plurality of branch lines connecting the repairing lines and the gate lines;
a gate insulating layer formed on the gate lines, the repairing lines, and the branch lines;
a plurality of first data lines formed on the gate insulating layer;
a plurality of second data lines formed on the gate insulating layer;
a plurality of drain electrodes separated from the first and second data lines and formed on the gate insulating layer;
a passivation layer formed on the first and second data lines and the drain electrodes; and
a plurality of pixel electrodes formed on the passivation layer and connected to the drain electrodes.

6. The thin film transistor array panel of claim 5, further comprising a plurality of connecting bridges configured to connect the first data lines and the second data lines.

7. A method of repairing a thin film transistor array panel that comprises an insulating substrate, a plurality of gate lines formed on the insulating substrate, a plurality of repairing lines formed on the insulating substrate, a plurality of branch lines connecting the gate lines and the repairing lines, a plurality of first data lines and a plurality of second data lines intersecting the gate lines and the repairing lines, a plurality of bridges connecting the first data lines and the second data lines, a plurality of thin film transistors connected to the gate line and the first data lines, and a plurality of pixel electrodes connected to the thin film transistors, the method comprising:
shorting two adjacent second data lines with two adjacent repairing lines;
disconnecting portions of the second data lines connecting the two adjacent repairing lines from the other portions of the second data lines and the first data lines; and
disconnecting a portion of one of the repairing line connecting the two adjacent second data lines from the other portions of the repairing line and the gate lines.

8. A method of repairing a thin film transistor array panel that comprises an insulating substrate, a plurality of gate lines formed on the insulating substrate, a plurality of repairing lines formed on the insulating substrate, a plurality of branch lines connecting the gate lines and the repairing lines, a plurality of first data lines and a plurality of second data lines intersecting the gate lines and the repairing lines, a plurality of bridges connecting the first data lines and the second data lines, a plurality of thin film transistors connected to the gate line and the first data lines, and a plurality of pixel electrodes connected to the thin film transistors, the method comprising:
shorting a first data line and a second data line adjacent to each other with two adjacent repairing lines;
disconnecting portions of the second data lines connecting the two adjacent repairing lines from the other portions of the second data lines and the first data lines; and
disconnecting portions of the repairing lines connecting the first data line and the second data line from the other portions of the repairing lines and the gate lines.
